(19) United States
(12) Patent Application Publication
(10) Pub. No.: US 2007/0169691 A1
(43) Pub. Date: Jul. 26, 2007

(54) Automatic retouching device for a powder-coating booth

(76) Inventors: Jose Rodrigues, Saint-Gillaume (FR); Andre Surpi, Seyssinet-Pariset (FR)

Correspondence Address: CANTOR COLBURN, LLP, 55 GRIFFIN ROAD SOUTH, BLOOMFIELD, CT, 06002, US

(21) Appl. No.: 10/557,874

(22) PCT Filed: May 19, 2004
(86) PCT No.: PCT/FR04/01249

§ 371 Date: Feb. 8, 2007

(30) Foreign Application Priority Data
May 22, 2003 (FR) 03/06171

(51) Int. Cl. B05C 19/00; B05B 7/06

(52) U.S. Cl. 118/309; 118/308; 118/313

(57) ABSTRACT

The invention relates to a device (17) which is used to spray a coating product in powder form onto a part (5), particularly for automatic retouching, and which is intended for an application booth (3). The invention is characterised in that it comprises: an essentially-vertically column (18), at least two carriages (19) which can move independently in an essentially-vertical manner along the length of the column (18), and coating product-application guns (10) which are supported by the carriages (19). The invention is suitable for the automatic retouching or pre-touching of parts, performed in a complementary manner to the automatic application of a coating product

The present invention relates to automatic powder-coating plant and more particularly to a device comprising powder sprayers intended to spray powder onto complex parts.

The application of powder to mechanical parts of complex shape is performed in a known way by automatic plant comprising a spray booth through which the parts pass and spray guns spraying the powder essentially perpendicularly with respect to the axis of travel of the parts through the booth. This method of application is unable to apply a uniform thickness of powder to the entirety of the part.

As a result, certain particular regions of the parts require an additional application or intensification performed before or after the automatic application, this application being known as a pre-touch or a retouch, respectively.

The intensification may be performed manually, leading to a high cost, the need to employ highly specialist personnel, and the inability to achieve repeatable results.

The intensification may be performed by placing a series of automatic guns specialized in the application of powder to specific particular regions of each of the parts that are to be powder coated on a vertical boom fixed at the entrance or exit of the spray booth. This method entails manually positioning each of the guns in terms of height and in terms of depth to suit each different type of part and therefore dictates production down-times for setting-up and requires identical parts to be processed in batches.

The intensification may also be performed by placing, side by side against the spray booth, a series of 2-axis robots which have an axis for positioning in terms of height and an axis for positioning in terms of depth, each of these robots being equipped with an automatic spray gun. This solution entails positioning several robots of this type, as many as 8 or 10 such robots perhaps being required, leading to a lengthening of the booths, an increase in cost and an unacceptable amount of floor space required.

The intensification may also be performed by placing, at the entrance or the exit of the booth, a 6-axis robot capable of essentially reproducing the movements of a painter. However, this type of robot occupies a great deal of booth floor and wall space and the complexity of operating, maintaining and servicing it, combined with its cost, make it inappropriate for the vast majority of companies. Furthermore, 6-axis robots require wide openings in the walls of the booths, and this leads to a substantial increase in the flow rates of air drawn into these booths which are kept at a lowered pressure so as to prevent powder from dispersing from the said booths.

An intensification device needs in addition to allow the spray guns to be inserted and extracted easily so that they can be cleaned each time the shade of powder changes.

The present invention allows the disadvantages of the abovementioned solutions to be alleviated while at the same time providing a great deal of operational flexibility, highly repeatable results, operation and servicing compatible with the capabilities of the personnel generally encountered, and which occupies a small amount of floor space.

To this end, the subject of the invention relates to a spray device for spraying a coating product in the form of a powder onto a part, particularly for automatic retouching work intended in particular for a spray booth, characterized in that it comprises:
an essentially vertical column,
at least two carriages able to move independently essentially vertically along the column,
spray guns for applying the coating product, these being supported by the carriages.

Arranging the guns such that they can move vertically provides a solution that reduces the amount of space occupied. Furthermore, this arrangement reduces the number and size of openings needed in the spray booth for the guns to pass through, just one vertical opening being required. The independence of the carriages guarantees great flexibility of use.

Advantageously, at least one carriage is associated with means allowing it to be moved and held in position over a continuous set of points along the column.

This arrangement guarantees that the intensification can be tailored to suit the specific shape of each of the parts.

In one embodiment, at least one of the carriages can move along a second axis of movement with respect to the vertical column.

Advantageously, the two axes of movement of the carriages are orthogonal.

In the case of certain parts which are very deep, it is necessary to be able to control the horizontal position of the guns in order to perform the intensification, and this second movement of the carriage allows for this control.

In one embodiment, at least one carriage is equipped with at least one servomotor, equipped with a brake, intended to move it.

In one embodiment, the carriages are equipped with pinions collaborating with at least one rack secured to the column.

Combining brake-equipped servomotors with a rack and pinion assembly allows the carriages and the guns to which they are secured to be moved and positioned precisely. The use of brakes allows the servomotors to be deactivated when the carriage is not in motion.

In one embodiment, an automatic controller controls the movement and position of the carriages and prevents collisions between carriages.

In one embodiment, the automatic controller slaves the movement and position of the carriages to a datum value so as to bring the guns opposite specific regions of the part.

The device is controlled by electronic means which allow the position of the guns to be slaved to the position of particular regions of the parts that need to be intensified. The information regarding the position of the regions may originate from various specialized devices such as cells situated at the entry to the spray booth for example.

Advantageously, the axes of the spray guns are contained in the same spray plane.

In one embodiment, the column is mounted on a motorized plinth able to move it in a plane essentially parallel to the spray plane.

In one embodiment, the column is mounted on a motorized plinth able to move it in a plane essentially perpendicular to the spray plane.

Since the depth of the part for retouching or pre-touching may vary, from a few centimeters to 1 meter for example, so the device may be prepositioned so that, on average, it is a suitable distance away from the part that needs to be processed. It is furthermore beneficial to be able to position the column laterally with respect to the openings made in the side wall of the spray booth.

The invention will be better understood with the aid of the description which follows, with reference to the attached schematic drawing which depicts some embodiments of a positioning device according to the invention.

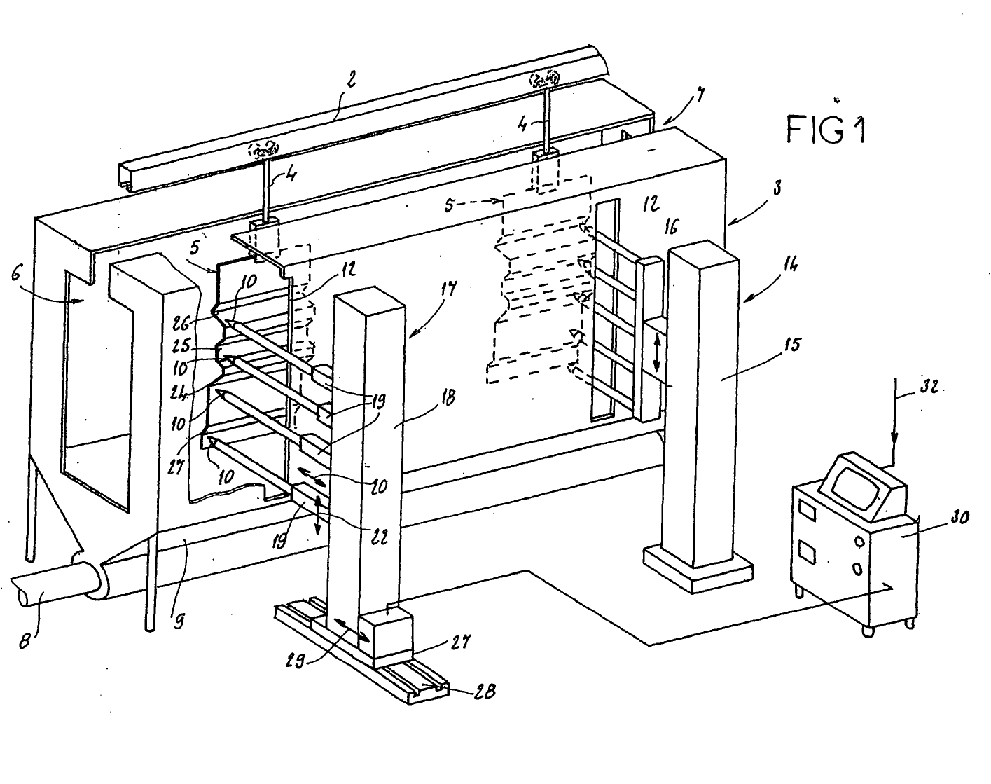

FIG. 1 is a schematic perspective view thereof in its environment, comprising an automatic spray plant for an embodiment involving two axes of positioning.

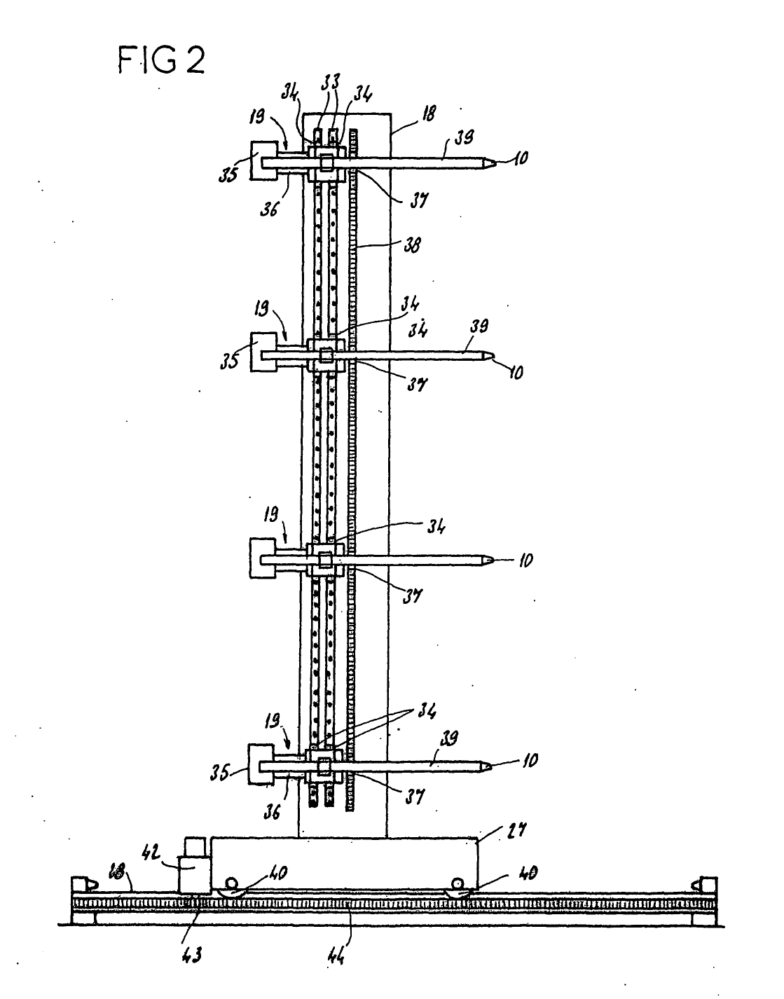

FIG. 2 is a side view thereof on a larger scale in an embodiment involving one axis of positioning.

FIG. 1 depicts a schematic overall view of an automatic plant for the powder-coating of parts in which plant a conveyor 2 conveys into a powder-coating spray booth 3 hanging trays 4 which support the parts 5 that are to be powder-coated, these parts entering the booth via an entry opening 6 and re-emerging therefrom, powder-coated, via an exit opening 7. The booth 3 is kept at a reduced pressure with respect to the external surroundings by a blower preceded by a filter or cyclone, none of which have been depicted, and connected by an air duct to the outlet 8 at the bottom of a bottom hopper 9 of the booth 3.

The powder sprayed by the spray guns 10, in this instance electrostatic spray guns, connected to suitable supply and control means, is deposited for the most part on the part 5, but 30 to 40% of this powder is not deposited and is carried along toward the filter by the air kept at a reduced pressure inside the booth.

The air for achieving the reduced pressure is drawn in from the workshop into the booth 3 via all the openings to the outside thereof and, in particular, via the entrance 6, exit 7 openings, the openings 12 for the passage of the supports that support the guns 10, and the opening 13 through which the hanging tray 4 passes.

Two spraying devices equipped with guns 10 are associated with the booth 3, the openings 12 allowing the guns 10 to pass inside the booth.

The first automatic device 14 is a conventional device comprising a vertical column 15 and a single carriage 16 which are associated with an appropriate drive mechanism not depicted. This device 14 imparts, for example to five superposed spray guns 10, a permanent up and down movement 21 of an amplitude and speed tailored to the number of guns 10 borne by the carriage 16 and to the rate of travel of the conveyor 2, so that a uniform electrified cloud of powder is directed from the guns 10 toward the parts 5 that are to be coated with powder.

The second spray device 17 that forms the subject of the invention is a pre-touching or retouching device. In the embodiment depicted schematically here, the device 17 comprises a vertical column 18 and four cross-motion carriages 19 the motions of which may or may not be perpendicular to the column 18, able to move independently of one another. A gun 10 is fixed on each of these four carriages 19, which can therefore move along the column 18 in the direction of the arrow 20 and/or perpendicular thereto, in the direction of the arrow 22, so as to spray a narrow and precise jet of powder onto the particular regions of the part 5 that the uniform cloud of powder disseminated by the automatic device 14 equipped with guns 10 has been unable to reach for electrostatic reasons concerned with the disruption of the field or concerned with a Faraday cage phenomenon, and/or mechanical reasons associated with direct accessibility.

Thus, the guns 10 secured to the carriages 19 are positioned opposite particular regions 23, 24, 25, 26 and retouch or pre-touch these particular regions.

As the depth of the part 5 may vary, from a few cm to 1 m for example, so the device 17 may be prepositioned in the direction of the arrow 29 by virtue of a plinth 27 running on rails on the ground 28 so that, on average, it can be positioned a suitable distance away from the part 5 that is to be processed.

The first automatic device 14 may also be equipped with this prepositioning system.

An electronic device 30 controls the movement of the carriages 19 along the two axes 20, 22 and the electrostatic characteristics of the flow rates of the powder and the characteristic of the jets of the powder from each of the electrostatic guns 10 according to a datum value 32. The datum value 32 is received from an appropriate means, not depicted, which may be a line of cells placed at the entry to the booth, or an automatic reader, placed at the entry to the booth 3, of barcodes placed on the hanging trays 4 or any other appropriate means.

For certain parts, it is of course possible to change the position of the guns 10 of the device 17 during spraying or to take one or more of them out of service and place it/them in a standby position.

FIG. 2 depicts a different embodiment of the spray device 17 by comparison with FIG. 1. In this embodiment, the guns 10 are constrained to moving in only the vertical direction with respect to the column 18.

The device 17 comprises a column 18 on which the carriages 19 move, each of these carriages being guided in its vertical movement by two ball-type guide rails 33 on which ball shoes 34 secured to the carriage 19 slide. Fixed to each carriage 19 are a servomotor 35 and reduction gearing 36 which drive a pinion 37 collaborating with a rack 38 secured to the column 18.

When the servomotor 35 is operated in one direction or the other it drives the carriage 19 up or down via its pinion 37 collaborating with the rack 38 secured to the column 18.

Each servomotor 35 is equipped with a brake, not depicted, which keeps the carriage 19 in position when the desired position has been reached, the servomotor 35 then being deactivated.

Each carriage 19 can thus be moved and held in position over a continuous collection of points along the column.

Each carriage 19 is additionally equipped with an encoder, not depicted, allowing its position along the column to be monitored.

A support arm 39 is fixed to each carriage 19, and has a spray gun 10 fixed to it.

The column 18 fixed on its plinth 27 can be positioned with respect to the axis of the conveyor via a collection of wheels 40 guided along rails 28 fixed to the ground and a reduction servomotor 42 driving a pinion 43 collaborating with a rack 44 fixed to the ground. According to a two-axis carriage embodiment, a motorized sub-carriage moving, for example, in a motion parallel to a plane containing the two guide rails 33 is fixed to some or all of the carriages 19, in place of the arms 39 supporting the guns 10.

Each gun 10 is then mechanically fixed to a subcarriage.

This subcarriage may be actuated by a servomotor, a stepping motor, a pneumatic motor or any other type of actuator via a system involving ball screws, rails and ball shoes, a belt drive system or any other equivalent system.

The invention is not restricted to the embodiment described but on the contrary encompasses all variants thereof.

1.-11. (canceled)

12. A spray device for spraying a coating product in a form of a powder onto a part, comprising:
an essentially vertical column,
at least two carriages able to move independently essentially vertically along the column,
spray guns for applying the coating product, the spray guns being supported by the carriages.

13. The device according to claim 12, wherein at least one carriage is associated with means allowing it to be moved and held in position over a continuous set of points along the column.

14. The device according to claim 12, wherein at least one of the carriages can move along a second axis of movement with respect to the vertical column.

15. The device according to claim 14, wherein the two axes of movement of the carriages are orthogonal.

16. The device according to claim 12, wherein at least one carriage is equipped with at least one servomotor, equipped with a brake, intended to move it.

17. The device according to claim 12, wherein the carriages are equipped with pinions collaborating with at least one rack secured to the column.

18. The device according to claim 12, wherein an automatic controller controls the movement and position of the carriages and prevents collisions between carriages.

19. The device according to claim 18, wherein the automatic controller slaves the movement and position of the carriages to a datum value so as to bring the guns opposite specific regions of the part.

20. The device according to claim 12, wherein axes of the spray guns are contained in the same spray plane.

21. The device according to claim 20, wherein the column is mounted on a motorized plinth able to move it in a plane essentially parallel to the spray plane.

22. The device according to claim 20, wherein the column is mounted on a motorized plinth able to move it in a plane essentially perpendicular to the spray plane.
